(19) United States
(12) Patent Application Publication
(10) Pub. No.: US 2008/0036129 A1
(43) Pub. Date: Feb. 14, 2008

(54) Multi-use jaws combined with plate and force screws

(76) Inventor: Jose C. Fajardo, Miami, FL (US)

Correspondence Address: Jose C. Fajardo, 7240 SW 12th Street, Miami, FL, 33144, US

(21) Appl. No.: 10/912,682

(22) Filed: Aug. 6, 2004

Related U.S. Application Data
(60) Provisional application No. 60/506,596, filed on Sep. 29, 2003.

(51) Int. Cl. B25B 1/10

(52) U.S. Cl. 269/90

(57) ABSTRACT

This project is a work tool with a cylindrical shape in its center to give space to the jaws that I have incorporated. Its top part also consists of a cylindrical plate with an optional diameter designed for strong work, also in this top plate you could connect other related tools. The bottom plate will be the support base and the part to attach to a working bench or any other suitable place.

### OBJECTIVES

1. To create a combination tool that can be used for different operations in manual work.
2. To increase workers productivity.
3. To protect the workers during different operations.
4. To protect and increase durability of other tools.
5. To increase the quality of the work performed.
6. To create something new for the industry.

### BACKGROUND

After observing construction sites, the jobs of electricians, plumbers, mechanics, and others, and all the tools in existence that allow them to perform their jobs. I realized that I could invent one tool with multiple uses that would serve for different applications and purposes and could be used in construction sites and shops.

### SUMMARY

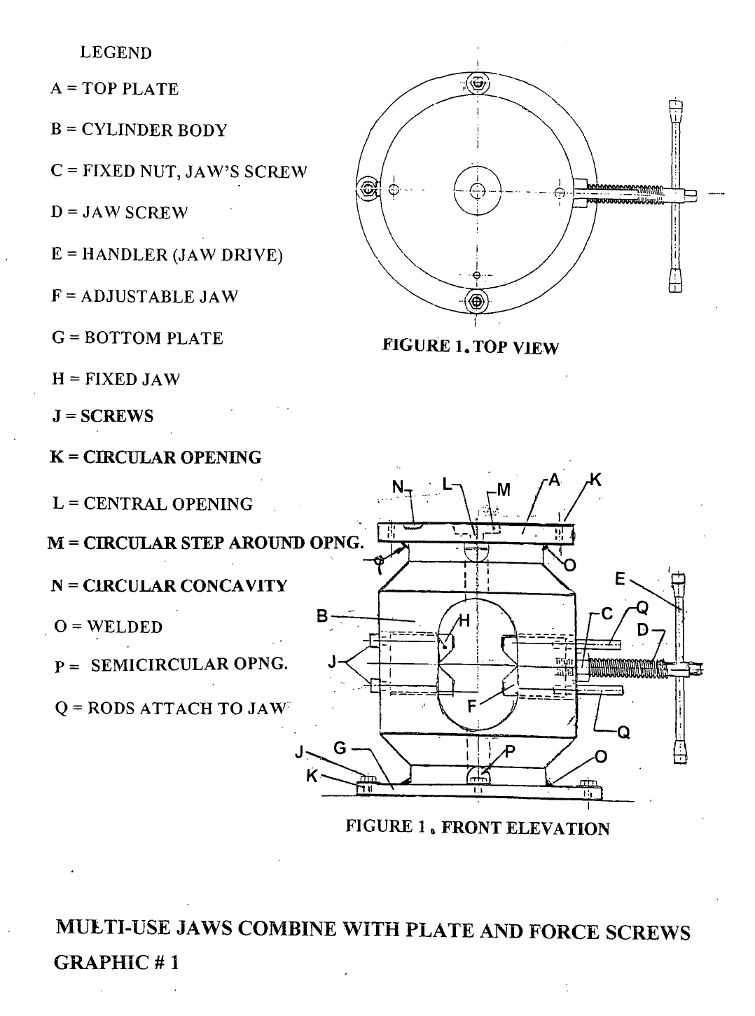

THIS TOOL IS A CYLINDER WITH TWO (2) OVAL SHAPE OPENINGS IN THE CENTER SECTION ONE IN FRONT IOF THE OTHER (SEE GRAPHIC 1 FIG. 1.

THE CYLINDER (SEE GRAPHICS 1 & 2 LETTER B) HAS INSIDE TWO JAWS (SEE GRAPHIC 1, FIG. 1 LETTERS F & H), ONE IS FIX AND THE OTHER IS ADJUSTABLE, ONE JAW IS ATTACH TO THE CYLINDER WITH FOUR SCREWS AND THE OTHER(THE ADJUSTABLE) IS KEEPING IN PLACE WITH TO CIRCULAR RODS (SEE GRAPHIC 1, FIG. 1 LETTER Q) BOTH ARE IN FROM EACH OTHER WITH THE SAME CENTRAL AXIS. THE CYLINDER HAS ONE (1) NUT WELDE (SEE GRAPHIC 1, FIG. 1 LETTER C), THE JAW'S SCREW PUCH THE ADJUSTABLE JAW AS REQUIRED.

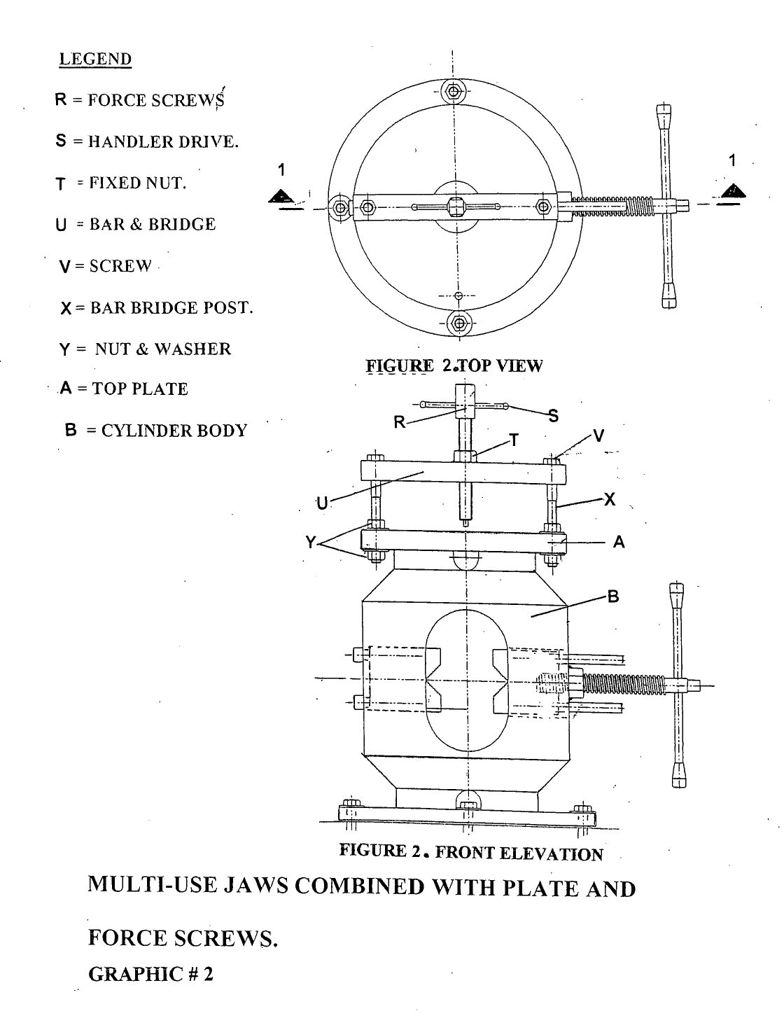

THE TOP AND BOTTOM PLATES ARE WELDED TO THE CYLINDER (SEE GRAPHIC 1, FIG. 1 LETTERS A & G) AND HAVE CIRCULAR OPENINGS THE BOTTOM OPENINGS ARE TO ATTACH THE CYLINDER TO A WORKING SURFACE AND THE OPENINGS AT THE TOP PLATE ARE TO ATTACH THE “BAR AND BRIDGE ADAPTER (SEE GRAPHIC 2, FIG. 2 LETTER U).

GRAPHIC 1 , FIG. 1. THIS IS THE FRONT ELEVATION AND THE TOP VIEW. WITH THE LEGEND FOR ALL THE PARTS OF THIS TOOL.

GRAPHIC 2, FIG. 2. SHOWN THE POSITION OF THE ADAPTER AND HIS ATTACH TO THE CYLINDER WITH THE LEGEND FOR THE PARTS.

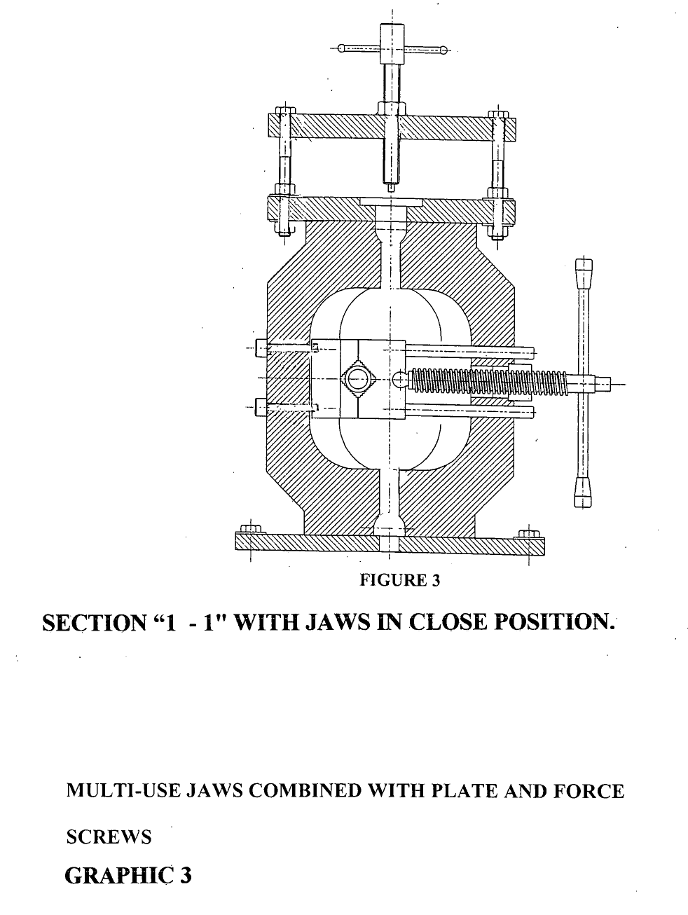

GRAPHIC 3, FIG. 3. SHOWN A SECTION TO THE CENTER LINE OF THE TOOL.

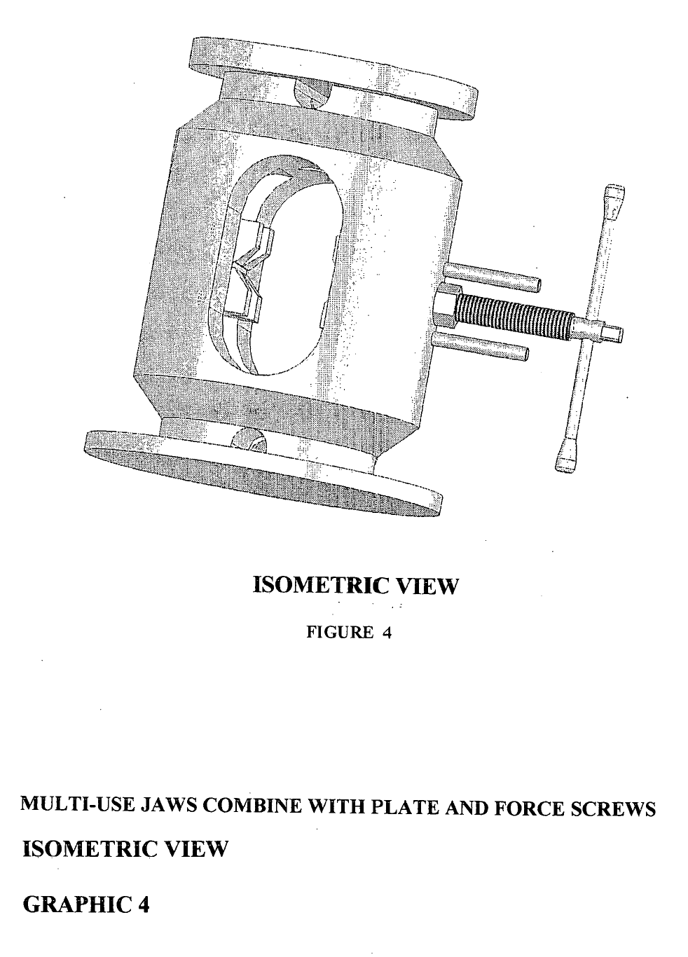

GRAPHIC 4, FIG. 4 IT IS AN ISOMETRIC VIEW.

1. It is a claim that in FIG. 1, (a) is a top plate with details m, l, n, k. This will allow it to perform several operations.

2. It is a claim in FIG. 1, that (b) is what allows the top plate, the fixed jaw and the moveable jaw to be attached.

3. It is a claim that in FIG. 1, that (d) allows the displacement of the moveable jaw.

4. It is a claim that in FIG. 1, that (c) allows the displacement of the jaw screw.

5. It is a claim that in FIG. 1, (h) holds objects while bearing the force from (d).

6. It is a claim that in FIG. 1, (o) allows the application of more force and makes the tool more solid.

7. It is a claim that in FIG. 1, (p) allows the tool to be lighter (weigh less) and the posterior cleaning.

8. This claim establishes that the superior and inferior plates are cylindrical and with a thickness greater than ⅜ of an inch or more.

9. It is a claim that the superior plate is prepared to connect auxiliary tools

10. It is a claim of this project that FIG. 2 is the superior auxiliary screw with all its details.

11. It is a claim that FIG. 1 and FIG. 2 are with all their details.

12. It is a claim that axles (q) fixed in jaw (f) will not allow turn during use.
